(19) United States
(12) Patent Application Publication
(10) Pub. No.: US 2006/0279089 A1
(43) Pub. Date: Dec. 14, 2006

(54) Door bolt safety lock

(76) Inventor: Jesse Cole, Petersham, MA (US)

Correspondence Address: NORMA E HENDERSON;HENDERSON PATENT LAW, 13 JEFFERSON DR, LONDONDERRY, NH, 03053, US

(21) Appl. No.: 11/445,512

(22) Filed: Jun. 2, 2006

Related U.S. Application Data
(60) Provisional application No. 60/686,631, filed on Jun. 2, 2005.

(51) Int. Cl. E05C 21/00

(52) U.S. Cl. 292/1

(57) ABSTRACT

A door bolt safety lock has a base unit attached to a top unit via a hinge, and a latching mechanism that engages when the top unit is closed over the bottom unit around a sliding bolt protrusion, preventing the sliding bolt from being moved until a release button is pressed. In operation, the latch engages the top and bottom units, compressing a spring and holding the device in the closed position until the latch release is pressed. In an alternate embodiment, the base unit is shorter than the top unit. The top unit is closed over the bottom unit and the sliding bolt protrusion, trapping the protrusion between the top unit and the door.

### RELATED APPLICATIONS

This application claims the benefit of U.S. Provisional Application Ser. No. 60/686,631, filed Jun. 2, 2005, the entire disclosure of which is herein incorporated by reference.

### FIELD OF THE TECHNOLOGY

The present invention relates to door and gate bolts and, in particular, to a safety lock that prevents accidental or otherwise unwanted door or gate opening.

### BACKGROUND

Sliding bolt locks are frequently found on all manner of doors, gates, cabinets, cupboards, and the like. In particular, stalls for livestock, such as horses, are very often secured with large sliding bolt locks, with the siding bolt typically having a U-type bend or other protrusion that doubles as a handle for opening and closing the door. While simple to use, as well as economical to buy and maintain, such locks have the drawback that they are also easy for a smart horse or other animal to learn to manipulate on their own. It is not uncommon for the owner of a smart horse to find that the horse has learned how to reach over the stall wall or gate, grab the protrusion, and unbolt the door, letting itself out of its stall or turnout to wander the barn, paddock, or neighborhood at will. Some horses have even been known to free their stablemates after freeing themselves. Clearly, this presents a serious safety hazard to the horse, and, depending on the temperament of the released animal or animals, may also present a hazard to persons or even vehicles in the vicinity. However, because of the ever-present danger of fire, it is also important that a stall or gate door always be able to be easily and quickly opened by an animal's human caretaker.

Sliding bolt locks are also frequently used to secure areas such as outdoor sheds, kitchen cabinets, cupboards, closets and the like. Commonly, it is desirable to keep the contents of these areas secure from children, but it is also necessary for them to be easily and quickly accessible to adults. This latter need makes the use of keyed or combination locks and other such mechanisms very inconvenient. What has been needed, therefore, is a safety mechanism that can secure a sliding bolt lock in a manner that prevents its unwanted or accidental opening, but is easy and quick to use when opening is desired.

### SUMMARY

The present invention is a door bolt safety lock that is designed to prevent a sliding bolt lock from being undesirably opened. It may be utilized with any sliding bolt that has a protrusion sufficiently long that it can be engaged within the device. The device may be attached to any surface to which a siding bolt lock is attached. In one embodiment, a base unit is attached to a top unit via a hinge. The base and top units have depressions on the top to accommodate a latching mechanism. When the top unit is closed over the bottom unit around the sliding bolt protrusion, the latching mechanism engages and the safety lock prevents the sliding bolt from being moved until a release button is pressed, releasing the latching mechanism and allowing the device to be opened. This embodiment is normally installed in a horizontal orientation.

In one embodiment of the latching mechanism, a top latch is attached through a latch guide in a spring stop and spring to a latch release block. The latching mechanism assembly is held in place by an assembly screw and is inserted into a latching mechanism hole in the base or top unit of the device. In operation, the top latch engages the top and bottom units at the respective depressions, compressing the spring and holding the device in the closed position until the latch release block is pressed. When the latch release block is pressed, the action of the spring causes the top latch to rise, releasing the top unit and allowing the device to be opened and the slide bolt to be released.

An alternate embodiment of the present invention permits locking of virtually any style of sliding bolt lock, including various novelty bolt styles. In this embodiment, the safety lock is normally installed in a vertical orientation, although it may also be utilized in the horizontal orientation if desired. The base unit in this embodiment is shorter than the top unit and is attached to the top unit at a hinge. In operation, the top unit of this embodiment is closed over the bottom unit and the sliding bolt protrusion, trapping the protrusion between the top unit and the mounting surface, thereby preventing any movement of the sliding bolt until the latch release is pressed.

### BRIEF DESCRIPTION OF THE DRAWINGS

Other aspects, advantages and novel features of the invention will become more apparent from the following detailed description of the invention when considered in conjunction with the accompanying drawings wherein:

FIGS. 1A and 1B are front and back views of an example embodiment of the door bolt safety lock of the present invention when in the open position;

FIGS. 2A and 2B are views of an embodiment of a latch mechanism according to one aspect of the present invention, shown in the disassembled and assembled states, respectively;

FIGS. 3A-C are successive views of an embodiment of the safety lock of the present invention in operation, FIG. 3A showing the lock open without the sliding bolt engaged in the safety latch, FIG. 3B showing the sliding bolt engaged in the safety lock, and FIG. 3C showing the safety lock closed around the engaged sliding bolt;

FIG. 4 is a bottom view of the safety lock of the present invention in the closed position;

FIGS. 5A and 5B are top views of the safety lock of FIGS. 3A-C in the closed position, showing the safety lock closed without and with an engaged sliding bolt, respectively;

FIGS. 6A and 6B are front views of an alternate embodiment of the door safety lock of the present invention when in the open and closed positions respectively;

FIGS. 6C and 6D are back views of an alternate embodiment of the door bolt safety lock of the present invention when in the closed and open positions respectively;

FIGS. 7A and 7B are front and end views of the embodiment of FIGS. 6A-D when the safety lock is partially closed;

FIGS. 8A and 8B are views of the end of the embodiment of FIGS. 6A-D, showing the latch release when the lock is partially and fully closed, respectively; and

FIGS. 9A and 9B are open and closed views of the embodiment of FIGS. 6-8 while being employed to secure a novelty bolt lock.

### DETAILED DESCRIPTION

The present invention is a safety lock that is designed to prevent a sliding bolt lock from being undesirably opened. The invention may be utilized with any sliding bolt that has a protrusion sufficiently long that it can be engaged within the device. It may be easily installed as a separate add-on to previously installed sliding bolt locks, without having to remove the sliding bolt lock for installation. Once installed and assembled on a door or gate, it may be employed to engage the protrusion of the siding bolt and prevent the door from being opened when not desired. A particular advantage of the present invention is that it does not engage automatically, so that the sliding bolt lock can continue to be used alone whenever the extra security of the present invention is not required.

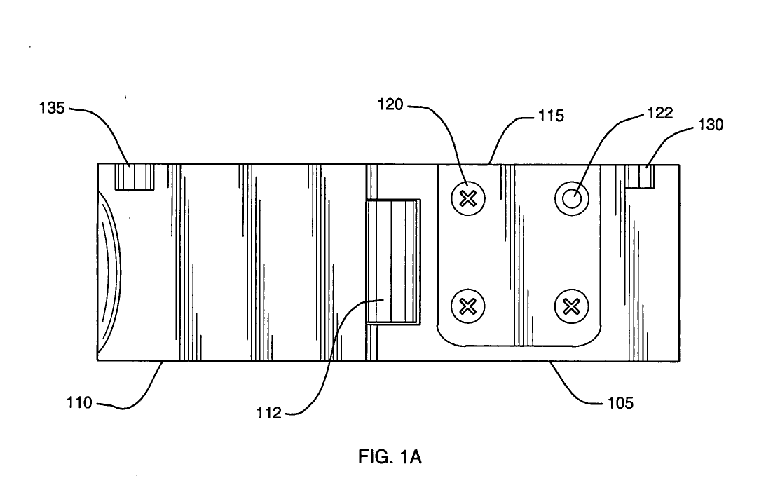

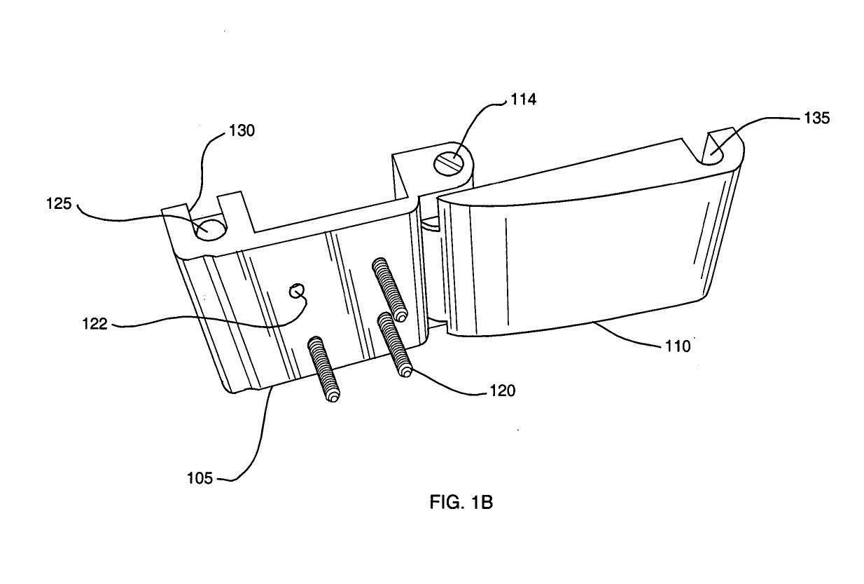

The door bolt safety lock of the present invention is preferably made of molded plastic or cast metal, but any other suitable material or method of manufacture known in the art may be substituted. FIGS. 1A and 1B are front and back views of an example embodiment of the door bolt safety lock of the present invention when in the open position. In FIG. l A, base unit 105 is attached to top unit 110 at hinge 112. Base unit 105 has base plate area 115 with holes 122 through which screws 120 are placed for attaching the device to a door. While four screws are shown, it is clear that any suitable number and type of screw or other device for attaching the lock to the desired surface may be used. Base unit 105 further has depression 130 for receiving the top of the latching mechanism, and top unit 10 has a corresponding depression 135.

In FIG. 1B, a back view of the embodiment of FIG. 1A, base unit 105 has holes 122 through which screws 120 are inserted and depression 130 for receiving the top of the latching mechanism. Top unit 110 has a corresponding depression 135. Base unit 105 further has latching mechanism hole 125 for receiving the latching mechanism, as well as hinge pin 114 for retaining base unit 105 and top unit 110 at hinge 112 (FIG. 1A). In the embodiment of FIGS. 1A and 1B, hinge pin 114 is a screw inserted through hinge 112 and secured at the far end with a nut, but clearly any type of hinge, hinge pin, and/or hinge mechanism known in the art may be advantageously employed in the present invention.

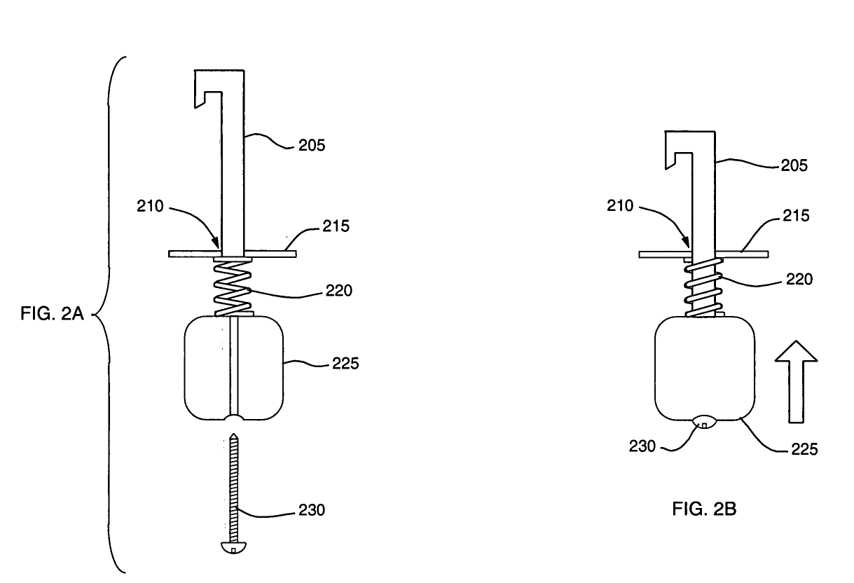

FIG. 2A depicts an embodiment of the latching mechanism according to one aspect of the present invention, shown in the disassembled state. FIG. 2B depicts the embodiment of FIG. 2A in the assembled state. In FIGS. 2A and B, top latch 205 is attached through latch guide 210 in spring stop 215 and spring 220 to latch release block 225. The latching mechanism assembly is held in place by assembly screw 230 and is inserted into latching mechanism hole 125 (FIG. 1B) in base unit 105 (FIGS. 1A and 1B). In operation, top latch 205 engages top unit 110 (FIGS. 1A and 1B) at depression 135 (FIGS. 1A and 1B), compressing spring 220, and holding the device in the closed position until latch release block 225 is pressed. When latch release block 225 is pressed, the action of spring 220 causes top latch 205 to rise, releasing top unit 110 and allowing the device to be opened and the slide bolt to be released. While the latching mechanism shown is the currently preferred embodiment, it is to be understood that many other types of latching mechanisms known in the art are suitable for use with the present invention and may be advantageously employed.

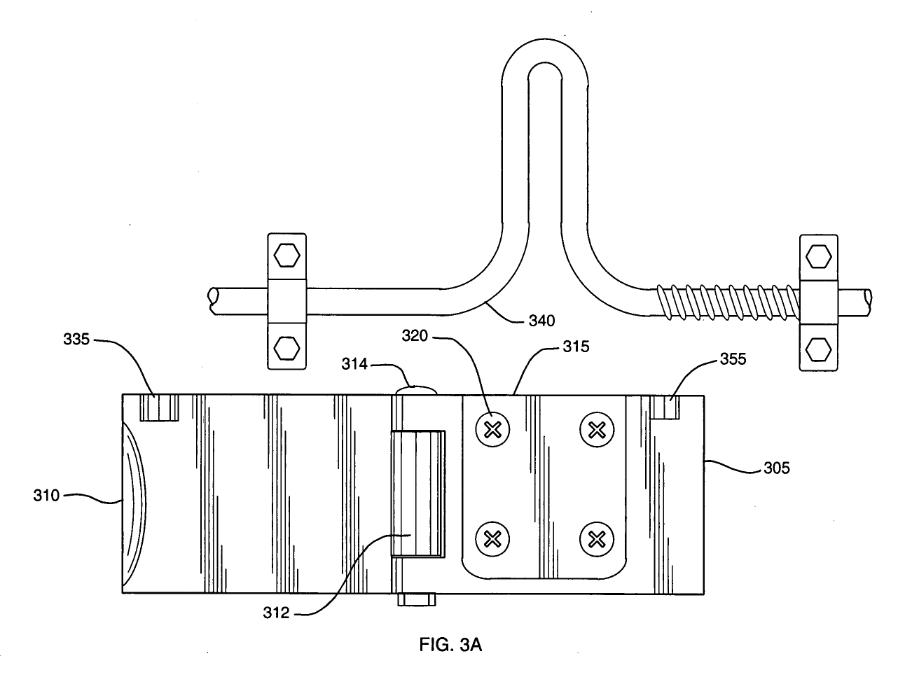

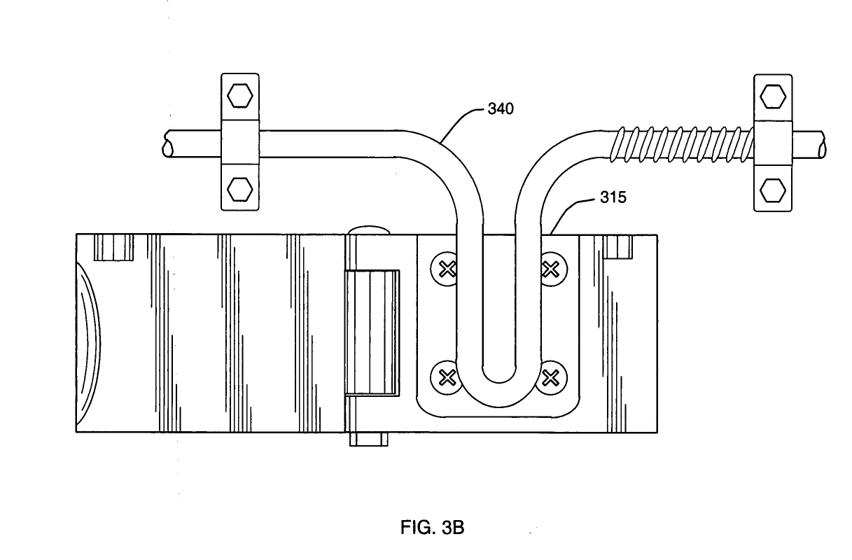

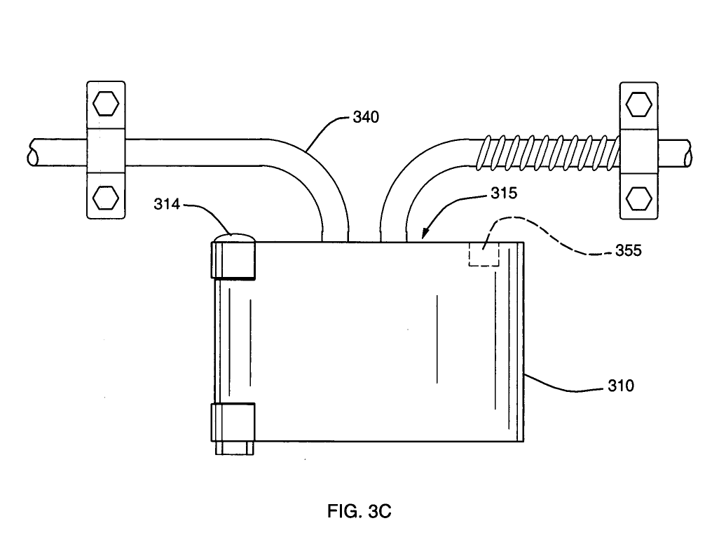

FIG. 3A shows an embodiment of the present invention in the open position, without a sliding bolt engaged in the safety lock. FIG. 3B shows the embodiment of FIG. 3A in the open position, with a sliding bolt engaged in the safety lock. FIG. 3C shows the embodiment of FIGS. 3A and 3B when closed around the engaged sliding bolt. In FIG. 3A, base unit 305 is attached to top unit 310 at hinge 312 by hinge pin 314. Base unit 305 has base plate area 315 with holes through which screws 320 are driven into the desired surface. Top unit 310 has a depression 335 for receiving top latch 355 of the latching mechanism. In FIG. 3A, slide bolt 340 is not engaged in the safety lock. In FIG. 3B, the U-bend of slide bolt 340 has been engaged in the safety lock, resting against base plate 315. In FIG. 3C, top unit 310 has been closed over the U-bend of engaged slide bolt 340, allowing top latch 355 to engage top unit 310.

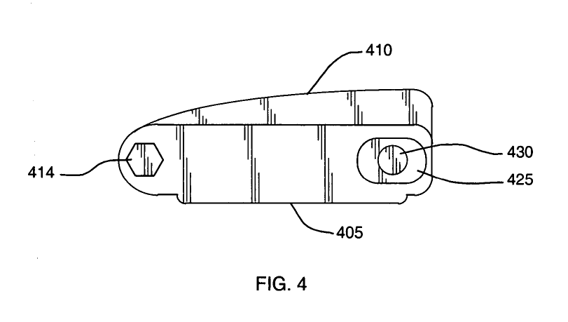

FIG. 4 is a bottom view of the safety lock of the present invention in the closed position, showing the bottom of hinge pin 414 connecting base unit 405 and top unit 410 and latch release block 425 and assembly screw 430 of the latching mechanism. While latch release 425 is pictured as being on the bottom of the device when installed, with the latch hook being on the top of the device, it is clear to one of ordinary skill in the art that the latch hook release may alternatively be located on the top of the device and the latch hook on the bottom, if such orientation were more desirable for a particular application. Similarly, while latch release 425 is pictured as being installed in base unit 405 of the device, with the latching mechanism being inserted into an opening in base unit 405, it is clear to one of ordinary skill in the art that the latching mechanism and latch hook release may alternatively be installed in top unit 410, if such orientation is more desirable for a particular application.

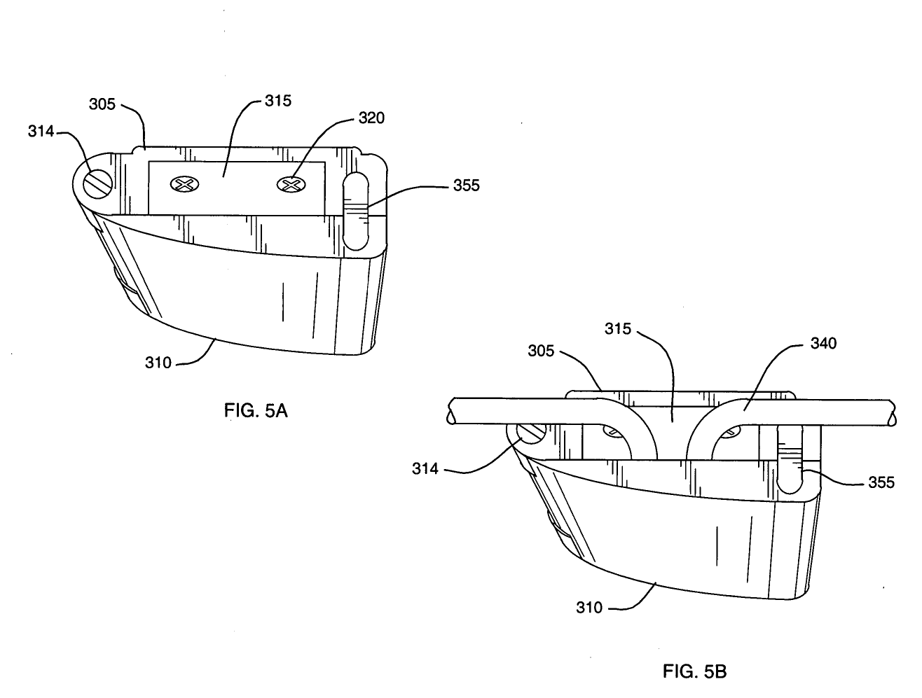

FIGS. 5A and B are top views of the safety lock of FIGS. 3A-C in the closed position, shown with and without a sliding bolt engaged in the safety lock, respectively. In FIG. 5A, base unit 305 is attached to top unit 310 by hinge pin 314. Base unit 305 has base plate area 315 with holes through which screws 320 are driven into the desired surface. Top unit 310 has received top latch 355 of the latching mechanism. In FIG. 5B, the U-bend of slide bolt 340 is engaged in the closed safety lock between bottom unit 305 and top unit 310, resting against base plate 315. Top latch 355 engages top unit 310, maintaining the safety lock in the closed position until the release mechanism is pressed.

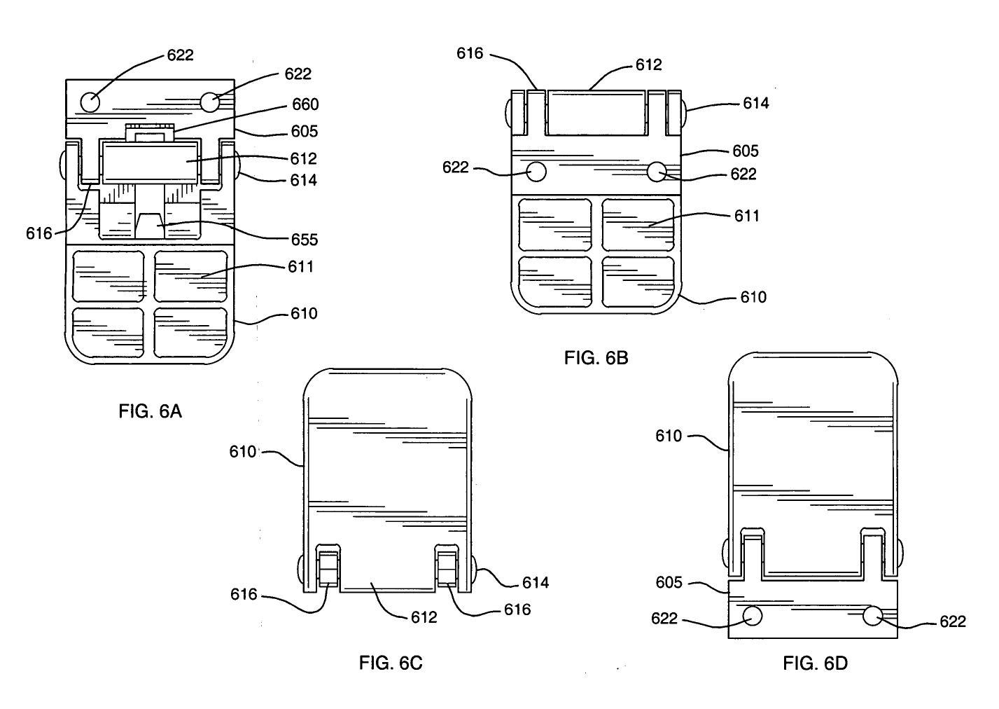

Since not all door bolts employ U-bends or other narrow extensions that can be easily locked into the embodiment of FIGS. 1-5, an alternate embodiment of the present invention permits locking of virtually any sliding bolt lock, including various novelty bolt styles, such as the horseshoe and horse-and-buggy shapes currently on the market. In this embodiment, the safety lock is normally installed in a vertical orientation, rather than the horizontal orientation typically employed with the previous embodiment, although it may also be installed in a horizontal orientation if desired. When the lock is closed and the sliding bolt protrusion is engaged, the protrusion is trapped between the top unit and the surface on which the safety lock is mounted. FIGS. 6A-D are views of this alternate preferred embodiment.

FIG. 6A is a front view of the alternate embodiment of the door safety lock of the present invention when in the open position. In FIG. 6A, base unit 605 is shorter than top unit 610 and is attached to top unit 610 at hinge 612, 616 by hinge screw 614. While hinge pin 614 is depicted as a screw inserted through hinge 612, which is part of top unit 610, and hinges 616, which are part of base unit 605, clearly any type of hinge, hinge pin, and/or hinge mechanism known in the art may be advantageously employed in the present invention. Top unit 610 is shown with optional depressions 611 that are employed to decrease the weight and cost of the device, but clearly the top unit may be solid or may have any other configuration that meets the product specifications and/or manufacturing considerations.

Base unit 605 has holes 622 through which screws (not shown) are placed for attaching the device to a door. While two holes 622 are shown, it is clear that any suitable number and type of screw or other device for attaching the lock to the desired surface may be used. Base unit 605 further has loop 660 for receiving latch hook 655. While in the embodiment shown, latch hook 655 is pictured as being installed in top unit 610 of the device, with catch loop 660 being located in base unit 605, it is clear to one of ordinary skill in the art that the configurations of base unit 605 and top unit 610 may be modified so that the latching mechanism may be alternatively installed in base unit 605 and loop 660 may alternatively be located in top unit 610, if such orientation is more desirable for a particular application.

FIG. 6B is a front view of the embodiment of FIG. 6A when in the closed position. In FIG. 6B, base unit 605 is attached to top unit 610 at hinge 612, 616 by hinge pin 614. Base unit 605 has holes 622 through which screws are placed for attaching the device to a door. In operation, the side of base unit 605 depicted in FIG. 6B lies against the door being secured.

FIGS. 6C is a back view of the embodiment of FIGS. 6A and B when in the closed position. In FIG. 6C, top unit 610 is attached to the base unit, which is folded up underneath top unit 610 and therefore not shown, at hinge 612, 616 by hinge pin 614. FIG. 6D is a back view of the embodiment of FIGS. 6A-C when in the open position, showing top unit 610 attached to base unit 605 and holes 622 through which the screws are placed.

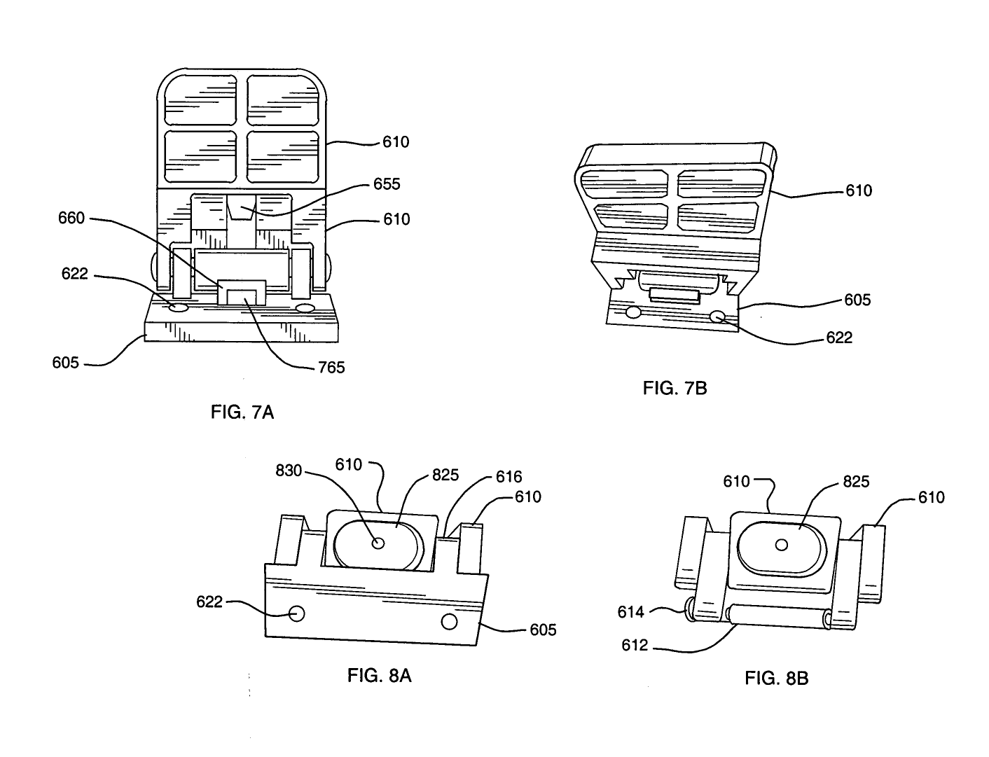

FIGS. 7A and 7B are front and end views of the embodiment of FIGS. 6A-D when the lock is partially closed. In FIGS. 7A and 7B, base unit 605 is attached to top unit 610 and has holes 622 through which screws (not shown) are placed for attaching the device to a door. Also shown is loop 660 for receiving latch hook 655 into opening 765.

FIGS. 8A and 8B are views showing the latch release of the embodiment of FIGS. 6A-D when the lock is partially and fully closed, respectively. In FIG. 8A, base unit 605 is attached to top unit 610 at hinges 616, which are part of base unit 605. Shown in top unit 610 is latch release 825 and assembly screw 830 of the latching mechanism. To release the safety lock, latch release 825 is pressed, pushing up latch hook 655 (FIG. 6A) and releasing it from loop 660 (FIG. 6A), allowing the safety lock to be opened. In FIG. 8B, the base unit is attached to top unit 610 at hinges 612, 616 by hinge pin 614. Also shown is latch release 825.

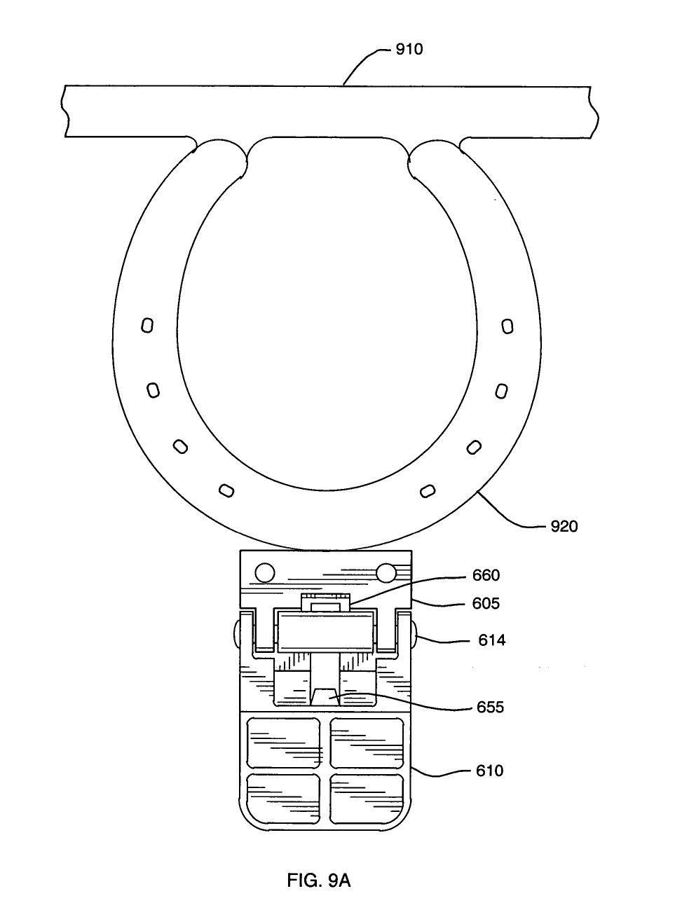

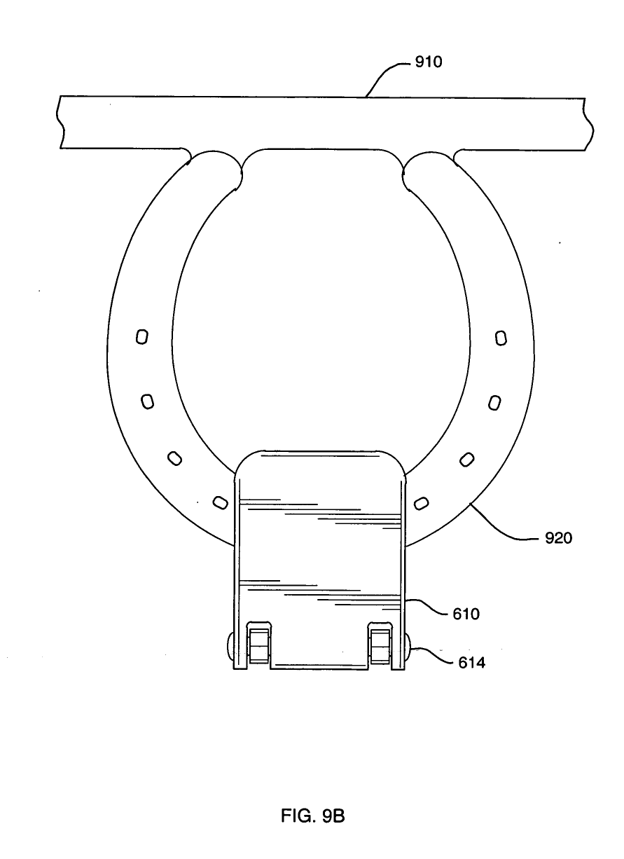

FIGS. 9A and 9B are open and closed views of the embodiment of FIGS. 6-8 when being employed to secure horseshoe-shaped novelty bolt 910. In FIG. 9A, top unit 610 is open in preparation for being closed over bottom unit 605 and horseshoe portion 920 of novelty bolt 910 so that latch hook 655 engages loop 660. In FIG. 9B, top unit 610 is closed over the bottom unit (not visible) and horseshoe portion 920, trapping horseshoe portion 920 between top unit 610 and the mounting surface, and thereby preventing any movement of novelty bolt 910. It is clear to one of ordinary skill in the art that other types of novelty-shaped bolts, as well as the traditional U-bolts and bolts with straight T-type (non U) extensions, may be safely and advantageously locked with the safety lock of this embodiment.

While the embodiments shown are intended to be employed in particular with the types of slide bolts found on stall and gate doors, it is clear that the safety lock of the present invention may also be easily modified by one of ordinary skill in the art to be used in a household, garden, or care-giving setting for the safety of children or others needing special protection. For example, it may be easily and advantageously modified and/or utilized by one of ordinary skill in the art to secure the various types of sliding bolt locks found on many cupboards, cabinets, screen doors, sheds, and windows, including those having a straight, T-type extension that may be used as a handle instead of a U-bend and all conceivable novelty shapes. Such modifications are specifically contemplated and are to be considered to be within the scope of the invention.

While a preferred embodiment is disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention, which is not to be limited except by the claims that follow.

What is claimed is:

1. A safety lock for preventing opening of a sliding bolt lock having a protrusion on the sliding bolt, comprising:
a top unit;
a base unit hingeably connected opposite the top unit;
a safety latch mechanism installed in the top or base unit for releaseably engaging the opposite unit when the top unit is closed over the sliding bolt protrusion; and
a latch release installed in the top unit or base unit for releasing the safety latch mechanism.

2. The safety lock of claim 1, wherein the latch release is spring operated.

3. The safety lock of claim 1, wherein the base unit is of a length long enough to permit the sliding bolt protrusion to be caught between the top unit and the base unit when the lock is engaged.

4. The safety lock of claim 3, wherein the safety latch mechanism and latch release are installed in the base unit.

5. The safety lock of claim 3, wherein the safety latch mechanism and latch release are installed in the-top unit.

6. The safety lock of claim 3, wherein the safety latch mechanism comprises a hook that engages a depression in the opposite unit when the lock is closed.

7. The safety lock of claim 3, wherein the safety latch release is located on the bottom of the lock when the lock is installed.

8. The safety lock of claim 3, wherein the safety latch release is located on the top of the lock when the lock is installed.

9. The safety lock of claim 1, wherein the base unit is of a length short enough that the sliding bolt protrusion is caught between the top unit and a surface upon which the lock is mounted when the lock is engaged.

10. The safety lock of claim 9, wherein the safety latch mechanism and latch release are installed in the top unit.

11. The safety lock of claim 9, wherein the safety latch mechanism and latch release are installed in the bottom unit

12. The safety lock of claim 9, wherein the safety latch mechanism comprises a hook that engages a loop in the opposite unit when the lock is closed.

13. A safety lock, comprising:
a top unit;
a base unit hingeably connected opposite the top unit, the base unit and the top unit when closed together defining a hollow for receiving a sliding bolt protrusion; and
a safety latch installed in the base unit for releaseably engaging the top unit when the top unit and the bottom unit are closed over the sliding bolt protrusion, the safety latch comprising:
a latch hook; and
a latch release located at the base of the spring.

14. The safety lock of claim 13, the safety latch further comprising a spring mechanism between the latch hook and the latch release.

15. A safety lock, comprising:
a top unit;
a base unit hingeably connected opposite the top unit, the base unit being shorter than the top unit so that the top unit extends past the base unit when the top and base unit are closed together;
a catch loop located on the base unit; and
a safety latch installed in the top unit for releaseably engaging the base unit when the top unit is closed over the bottom unit and a sliding bolt protrusion, comprising:
a latch hook for engaging the catch loop when the lock is closed; and
a latch release.

16. The safety lock of claim 15, the safety latch further comprising a spring mechanism between the latch hook and the latch release.
